(19) United States
(12) Patent Application Publication
(10) Pub. No.: US 2017/0060986 A1
(43) Pub. Date: Mar. 2, 2017

(54) SYSTEMS AND METHODS FOR DETECTION OF CONTENT OF A PREDEFINED CONTENT CATEGORY IN A NETWORK DOCUMENT

(71) Applicant: Shine Security Ltd., Herzlia Pituach (IL)

(72) Inventors: Ianir IDESES, RaAnana (IL); Assaf NEUBERGER, RaAnana (IL); Ron PORAT, RaAnana (IL); Oren FARAGE, Ramat-Gan (IL); Itay KATZ, Kfar-Saba (IL); Doron SHAMIA SADEH, Pardes-Hana-Karkur (IL); Alon BLAYER-GAT, Ramat-HaSharon (IL)

(21) Appl. No.: 15/238,756

(22) Filed: Aug. 17, 2016

Related U.S. Application Data
(60) Provisional application No. 62/211,902, filed on Aug. 31, 2015.

(51) Int. Cl. G06F 17/30; H04L 29/08; G06Q 30/02; G06F 17/21

(52) U.S. Cl. CPC G06F 17/30601; G06F 17/30011; G06F 17/212; H04L 67/10; G06Q 30/0277; H04L 67/02

(57) ABSTRACT

There is provided a method of identifying data object(s) of a predefined content category within a network document for presentation at a client terminal, comprising: receiving, at a network node at an internet service provider level of a network, web resource elements of a network document for rendering and presentation on a display associated with a client terminal; identifying data objects within the network document; extracting classification features from each data object; classifying at least one of the data objects into a predefined content category; generating reformatting instructions for adapting the presentation of the network document to reduce visibility of the data objects classified into the predefined content category upon rendering of the network document; creating a formatted network document by injecting the reformatting instructions into the network document for implementation by a rendering process executing on the client terminal; and transmitting the formatted network document to the client terminal.

### RELATED APPLICATION

This application claims the benefit of priority under 35 USC §119(e) of U.S. Provisional Patent Application No. 62/211,902 filed on Aug. 31, 2015, the contents of which are incorporated herein by reference in their entirety.

### FIELD AND BACKGROUND OF THE INVENTION

The present invention, in some embodiments thereof, relates to classification of data objects and, more specifically, but not exclusively, to methods and systems for automatic classification of data objects and formatting of network documents.

Internet advertising has becoming in recent years one of the most prominent methods of advertising as a whole. In 2013, Internet advertising revenues in the United States totaled $42.8 billion, a 17% increase over the $36.57 billion in revenues in 2012.

Advertising is usually conveyed using text, logos, animations, videos, photographs, or other graphics, which may take up a significant portion of on-screen space available for viewing of the desired non-advertisement content, and may take up a significant portion of network bandwidth used to access websites to obtain the desired content. Screen space and network bandwidth which becomes especially scarce in mobile device which have small screens and are connected to the internet using wireless links.

As online ads have become intrusive, methods to attempt removal or blocking of such ads have emerged, for example, plugins that may be downloaded and installed within web browsers.

### SUMMARY OF THE INVENTION

According to an aspect of some embodiments of the present invention there is provided a computer-implemented method of identifying at least one data object of a predefined content category within a network document for presentation at a client terminal, comprising: receiving, at a network node at an internet service provider (ISP) level of a network, web resource elements of a network document for rendering and presentation on a display associated with a client terminal; identifying a plurality of data objects within the network document; extracting a plurality of classification features from each data object; classifying at least one of the data objects into a predefined content category; generating reformatting instructions for adapting the presentation of the network document to reduce visibility of the data objects classified into the predefined content category upon rendering of the network document; creating a formatted network document by injecting the reformatting instructions into the network document for implementation by a rendering process executing on the client terminal; and transmitting the formatted network document to the client terminal.

Optionally, the predefined content category is ad-related content or user accessed content.

Optionally, at least some extracted classification features are at least one of: common to different ad-related content objects, and common to ad-related content and user-accessed content. Optionally, the extracted classification features include classification features that are statistically insignificantly correlated with ad-related content and user-accessed related content. Optionally, wherein the extracted classification features common to different ad-related content objects comprises extracted classification features common to different ad-related content objects originating from different ad server sources.

Optionally, the classifying is performed on at least one new data object representing a new observation to a trained statistical classifier performing the classifying, that at least one new data object excluded from a training set used to train the statistical classifier.

Optionally, the method further comprises at least one of blocking and removing the classified objects from the network document; and wherein generating reformatting instructions comprises generating reformatting instructions to at least one of: prevent errors from the blocking and removing of the classified objects, and reformat remaining data objects according to the blocking and removing of the classified objects.

Optionally, the injected code is automatically generated according to an analysis of data objects in the vicinity of each data object classified into the predefined content category.

Optionally, the extracted classification features include a relative location of the respective data object within a rendered version of the network document.

Optionally, the classifying is performed by a trained statistical classifier that is trained using a training dataset of data objects tagged with the predefined content category and other data objects not tagged with the predefined content category.

Optionally, the extracted classification features include local visual classification features of an image or video.

Optionally, the extracted classification features include static metadata related to the respective data object of the predefined content category.

Optionally, the extracted classification features include a graph representation of the network document.

Optionally, classifying comprises classifying a media type of the data object, and outputting comprises outputting an indication of the identified media type.

Optionally, the plurality of data objects comprises at least one of: images, video, banners, web code, and text.

According to an aspect of some embodiments of the present invention, there is provided a network node at an ISP level of a network for identifying at least one predefined content category data object within a network document for presentation at a client terminal, comprising: a network interface for communication with a network at the ISP level transmitting web resource elements of a network document for rendering and presentation on a display associated with a client terminal; a program store storing code; and a processor coupled to the network interface and the program store for implementing the stored code, the code comprising: code to identify a plurality of data objects within the network document, extract a plurality of classification features from each data object, and classify at least one of the data objects into a predefined content category, generate reformatting instructions for adapting the presentation of the network document to reduce visibility of the data objects classified into the predefined content category upon rendering of the network document, create a formatted network document by injecting the reformatting instructions into the network document for implementation by a rendering process executing on the client terminal; and code to transmit the formatted network document to the client terminal using the network interface.

Optionally, the method further comprises code to at least one of block and remove the classified data objects from the formatted network document, and wherein generating code comprises generating reformatting instructions to at least one of: prevent errors from the blocking and removing of the data objects, and reformat remaining data objects according to the blocking and removing of the ad-related data objects.

Optionally, the network node is located on network transmission pathway between the client terminal and a server hosting the network document.

According to an aspect of some embodiments of the present invention, there is provided a method for training a statistical classifier to classify objects of a network document into a predefined content category for presentation at a client terminal, comprising: receiving a training dataset of web resource elements of a network document for rendering and presentation on a display associated with a client terminal, each network document associated with a plurality of identified data objects, each data object associated with a classification label representing the predefined content category or not representing the predefined content category; extracting a plurality of classification features from each data object, wherein at least some extracted classification features are at least one of: common to different data objects of the same predefined content category, and common to different data objects of different categories; and training a statistical classifier for classification of a newly received data object excluded from the training dataset, using the extracted classification features and the classification label associated with respective data objects; and providing the trained classifier to a network node at the ISP level in communication with at least one client terminal over a network, for centralized real-time classification of data objects into the predefined content category and reformatting the network document by injection of reformatting instructions therein to reduce visibility of the classified data objects upon rendering of the formatted network document by a client terminal.

Optionally, the method further comprises creating, for at least one set of extracted classification features, a single generalized classification feature that includes each member of the set of extracted classification features.

Optionally, the method further comprises selecting a subset of the classification features for extraction from each data object according to a real-time computing performance requirement of at least one of a network node and a network in a transmission pathway of the data for rendering into the network document transmitted from the network document server to the at least one client terminal for local rendering and presentation on a display associated with client terminal.

Optionally, each network document comprises ad-related content and user-accessed content from a network document server, wherein the predefined content category represents at least ad-related content.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of identifying a predefined content category within web resource elements of a network document, in accordance with some embodiments of the present invention;

FIG. 2 is a block diagram of components of a system including a network node at an internet service provider (ISP) level that identifies a predefined content category within web resource elements of a network document, in accordance with some embodiments of the present invention;

FIG. 3 is a flowchart of a method for training a statistical classifier to classify data objects of web resource elements of a network document into a predefined content category, in accordance with some embodiments of the present invention;

FIG. 4 is a dataflow diagram of exemplary dataflow for creating a classifier that classifies data objects into a predefined content category, in accordance with some embodiments of the present invention; and

FIG. 5 is a dataflow diagram depicting a network node at the ISP level processing network traffic including web resource elements of a network document, and providing network traffic including filtered and/or formatted network documents for transmission to client terminals for local rending and presentation of the network documents, in accordance with some embodiments of the present invention.

### DESCRIPTION OF SPECIFIC EMBODIMENTS OF THE INVENTION

The present invention, in some embodiments thereof, relates to classification of data objects and, more specifically, but not exclusively, to methods and systems for automatic classification of data objects and formatting of network documents.

An aspect of some embodiments of the present invention relates to systems and/or methods to automatically and centrally classify data object(s) (e.g., text, images, banners, videos, and/or sound) of web resource elements (i.e., data for rendering) of a network document (e.g., webpage defined by a mark-up language or other rendering instructions defined by the web resource elements) destined for local rendering and presentation on a display of a client terminal, for example, by a web browser. The web resource elements of the network document may include, for example, hypertext mark-up language (HTML), cascading style sheets (CSS), and/or other code, script, and/or instructions. The classification may be performed by a network node at the ISP level (e.g., a tier 1 network), for example a proxy server, and/or a router. The network node processes and/or formats the network document within the network (e.g., packets), en route from a server (e.g., web server) to the client terminal, such that the client terminal receives the processed and/or formatted network document for local rendering and presentation. In this manner, the processing and/or formatting of the network document is performed centrally within the network, at the ISP level, by the network document, rather than at the client terminal. The processed data may require fewer resources (e.g., bandwidth, storage, processor utilization), which may improve efficiency and/or utilization of the network and/or the client terminal.

The web resource elements of the network document may include data objects of a predefined content category. Exemplary content categories may include, for example, non-desirable content (e.g., for blocking and/or removal), for example, advertisement-related content, and/or desired content, for example, user-accessed content (e.g., original non-advertisement content of the webpage requested by the user from the webpage server). Optionally, the data object is classified into one or more predefined content categories, for example, as related to user-accessed content, non-advertisement content, benign content, desired content, or other content. The classified object is identified based on extraction of classification features from the network document and/or data objects that are common to different data objects of the same predefined content category (e.g., the same classification feature is extracted from data objects originating from different sources) and/or common to data objects from different content categories, for example, both ad-related objects and user-accessed objects (e.g. the same classification feature is extracted from an advertisement and from user-accessed content).

Using the common classification features may allow identification of new ads (or other new data objects of the predefined content category) which may represent new observations to a classifier performing the classification, instead of, for example, identifying the presence of a known advertisement using predefined characteristics (e.g., signatures, uniform resource locator (URL), domain names, web code patterns, according to a predefined blacklist, and/or based on manual user identification). Moreover, the common classification features allow for a reduced classification features set to be used (e.g. as compared to a large dataset of specific characteristics).

The reduced classification feature set allows for removal and/or blocking of data objects of the predefined content category (e.g., ads) to be performed (optionally on newly observed ads) in real-time and/or using available computing resources (e.g., processors and/or memory). The classification of data objects into the general predefined content category (e.g., ad-related content) may reduce or prevent blocking of desired user-accessed content, for example, other methods that block all images or videos also block desired user-accessed content, as opposed to the systems and/or methods described herein that may distinguish images and videos as being ad-related or user-accessed related.

Optionally, the network document is analyzed as a whole to identify relative locations between objects. The relative location of the object may be extracted as a classification feature. For example, advertisements may consistently appear at the top or side of the network document, and/or in proximity to the user-accessed content. Alternatively or additionally, each data object of the network document may be independently classified as ad-related or user-accessed related content.

Optionally, instructions for reformatting and/or adapting the presentation of the network document are automatically generated.

Optionally, the network document is formatted (e.g., by injecting code) to reduce visibility of the classified data objects. The presentation of the network document may be adapted to compensate for removed and/or blocked classified data objects (e.g., indentified ad). The injected code may contain instructions to re-format the network document for presentation according to the removed and/or blocked predefined content categories (e.g., ad-related content), for example, to re-format user-accessed content to fit within space which has been designated for ads, by shifting the user-accessed content, expanding the user-accessed content, and/or changing the size of the user-accessed content text characters. The injected code may contain instructions to prevent the presentation of errors resulting from the blocking and/or removing of ad-related data objects, for example, a message (or icon or other visual representation) indicative of a non-functional link (to the ad server). The code injection is performed by the network node at the ISP level, within the network, before the web resource elements are locally rendered into the network document by the client terminal for presentation on the screen of the client terminal. The code injection is performed before the web resource elements arrive at the client terminal and/or web browser.

Optionally, the reformatting instructions (which are injected into the network document and/or into the web resource elements) are automatically created by the network node, to reduce visibility of the classified data object upon rendering of the network document.

The created and injected reformatting instructions may improve utilization of available screen space on the display of the client terminal, by making available screen space that would otherwise be used by the classified data objects (e.g., ads) and/or screen space that would otherwise display an error message (e.g., broken links to ads). Utilization of available screen space may be improved, for example, on devices with relatively small screens, for example, mobile devices, such as Smartphones, and/or wearable computers, for example, watch devices, and/or glasses devices.

An aspect of some embodiments of the present invention relates to systems and/or methods that train a statistical classifier that automatically classifies a data object within web resource elements that define rendering of a network document (e.g., webpage locally rendered by a web browser of a client terminal). The network document may include advertisement-related content and user-accessed related content (e.g., original content of the webpage), as relating to an advertisement or optionally to user-accessed content. The statistical classifier is generated for use by a network node at the ISP level that centrally processes data (e.g., packets) en route from a web server to a client terminal, for local rendering and presentation (e.g., by a web browser on a screen), for example, a proxy server of an internet service provider (ISP).

The statistical classifier may classify a newly observed data object, which has not been included within the training set. The statistical classifier is trained to perform the classification based on classification features extracted from the newly received data object and/or from the network document. The classification features may be common to different data objects of the same predefined content category, such as ad-related objects (e.g., the same classification feature is extracted from data objects originating from different sources) and/or common to data objects of different predefined content categories, for example, both ad-related objects and user-accessed objects (e.g. the same classification feature is extracted from an advertisement and from user-accessed content). In this manner, the statistical classifier may classify new data objects as being ad-related (or another predefined content category), without necessarily having been trained on the new data object, as opposed to, for example, methods that require knowledge of existing ads in order to identify the same ads (and/or ads from the same source), such as signature based methods and/or black list methods.

Optionally, a single classification feature is created as a generalization of all members of a set of classification features. The single classification feature may encompass (i.e. include) the classification features within the set. For example, the single classification feature ad* is a generalization of the following classification feature: ad, ads, advertisement, advertising, adware, and ad-here. The single classification feature reduces storage requirements and/or processing requirements, for example, as compared to extraction of members of the set of features instead of the single feature.

Optionally, the classification features for extraction from the newly received data object and classification using the trained statistical classifier, are selected according to a computing performance requirement of one or more network nodes, client terminals, and/or networks. The classification features are selected to allow for real-time classification of the data objects in the web page using the computing devices and/or for transmission over the network to the client terminal for presentation on a display. The selected classification features may include the generalized classification features.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the terms user-accessed content and ad-related content are examples of predefined content categories. Sometimes, the terms user-accessed content and/or ad-related content may be interchanged with the term predefined content category.

As used herein, the term web resource elements is interchangeable with the term data for rendering into a network document.

As used herein the terms ad and advertisement are interchangeable.

As used herein, the term classifier (or statistical classifier) broadly means a classification machine learning model, for example, a statistical classifier, a regression function, a look-up table, decision tree learning, artificial neural networks, and Bayesian networks.

As used herein, the term user-accessed content means non-advertisement content. The user-accessed content is the content requested by the user (e.g., via the web browser and/or client terminal) from the web server hosting the user-accessed content. The user-accessed content represents the desired content the user in interested in. The user-accessed content is different than the advertisements, which represent undesired content, which may be inserted into the network document containing the user-accessed content. The advertisements may originate from an ad-server which may be different than the server hosting the user-accessed content.

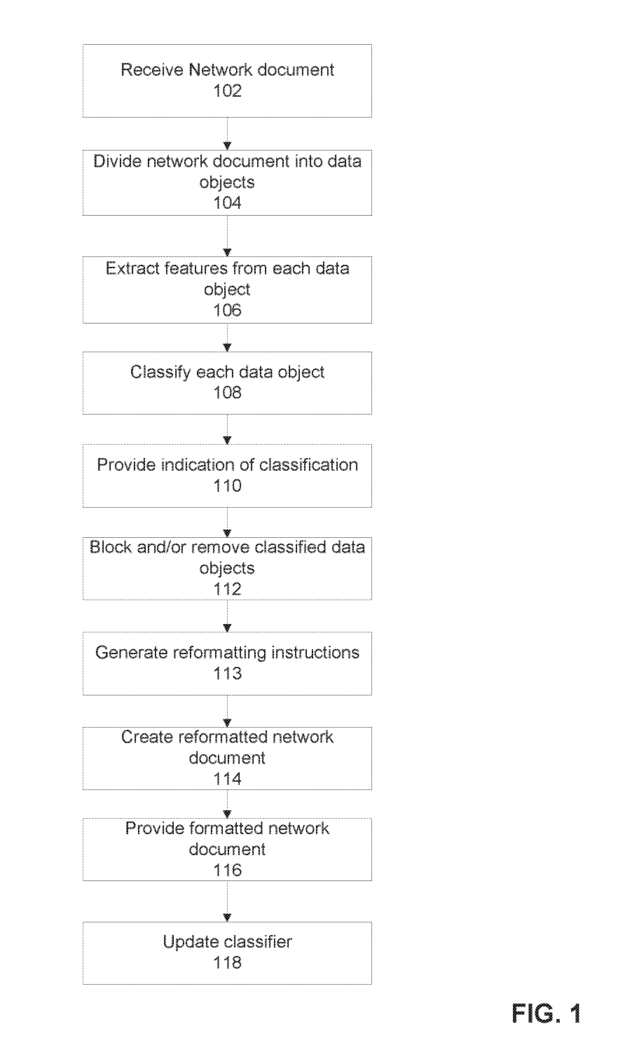

Reference is now made to FIG. 1, which is a flowchart of a method of identifying ad-related data objects (containing ad-related content) within data for rendering into a network document that includes ad-related content and user-accessed related content, in accordance with some embodiments of the present invention. The method classifies data objects of the web page as related to advertisements based on extracted classification features that are common to different ad content and/or common to both ad content and user-accessed content.

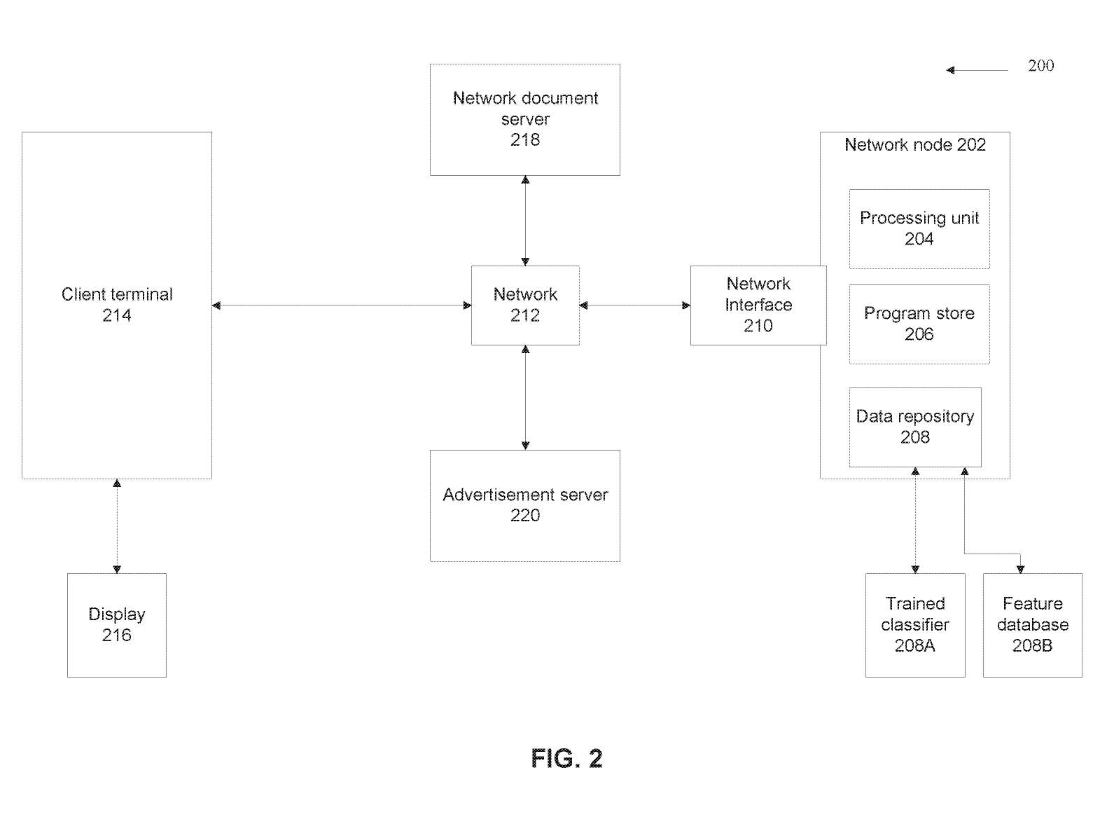

Reference is also made to FIG. 2, which is a block diagram of a system including a network node that receives data for rendering into a network document (e.g., marked-up text being accessed at a server from a client terminal), identifies ad-related content in data for rendering into the network document, and provides the processed data for rendering into the network document for transmission to the client terminal, in real-time (e.g., in less than about 1 second, or less than about 2 seconds, or less than about 5 seconds), in accordance with some embodiments of the present invention. The client terminal locally renders and presents the processed data, for example, using a web browser that presents the network document on a screen o the client terminal. The method of FIG. 1 may be executed by the system of FIG. 2.

The systems and/or methods described herein address a technical challenge that is particular to networks such as the internet, in particular, identification (for removal and/or blocking) of ad-related objects in data of a network document transmitted over the network. The ad-related objects pose an increased burden on the network, requiring extra network and/or computing resources for transmission over the network to the client terminal, for example, bandwidth, storage, and processor utilization. The systems and/or methods described herein are necessarily rooted in computer technology to overcome a problem arising in the realm of computer networks.

Optionally, the systems and/or methods described herein are necessarily rooted to computer technology to overcome a problem related to utilization of screen space, for example, in devices having relatively small screens (e.g., smartphones, watch computers, and glasses computers). The systems and/or methods described herein may inject code into the data for rendering of the network document, to reformat and/or correct the rendering according to blocked and/or removed ad-related objects. The injected code improves functioning of the basic display function of the client terminal rendering the data into the network document, by making available screen space that would otherwise be used by the ad-related objects. The available screen space may be used by other processes, and/or used to improve the other content of the network document.

The systems and/or methods described herein are directed towards a network node create a new version of the web resource elements of the network document, by reducing visibility of the data objects of a predefined content category when the network document is locally rendered at the client terminal. The network node may format the data to improve display of the rendered data of the client terminal, by correcting and/or reformatting the rendered data according to the blocked and/or removed ad-related objects.

The systems and/or methods described herein address the technical problem of automatic identification of advertising related content delivered within a network document. The identification is performed centrally, within the network at the ISP level, before the client terminal receives the data for local rendering and presentation on a display associated with the client terminal. A network node may centrally and in real-time perform the identification using a trained statistical classifier.

The systems and/or methods described herein may improve network performance, optionally of the wireless link with the client terminal, such as increasing available network bandwidth, improving network utilizing, and/or freeing up network processing resources (e.g., processor(s), memory and/or storage), by automatically identifying ad-related content, which may be removed and/or blocked. The identification may be performed based on extraction of a set of classification features selected to allow the identification process to be performed in real-time, without introducing significant delay to the user experience in loading webpages. The selected set of classification features may allow the real-time identification to be performed using designated processing resources, which may be limited in terms of processor(s) utilization and/or storage capacity. The identified ads (e.g., videos, audio, text, animations, and/or images) may require significant network resources for delivery from the ad server to the client terminal, for example, over limited resources such as wireless links. Automatically identifying the ads, and preventing and/or blocking transmission through the network frees up network resources for other desired traffic.

The systems and/or methods described herein may improve performance of a client terminal, such as improved utilization of a display, and/or improvement in processing resources of the client terminal (e.g., processor(s), memory, and/or storage), by automatically identifying ads, which may be removed and/or blocked. The identified ads, if allowed to be delivered within the network document, may take-up significant screen space, and/or may require significant processor(s) utilization and/or memory space for their display. Automatically identifying the ad-related content, and preventing and/or blocking the display of such ads on the display of the client terminal frees up screen space, processor(s), and/or memory for other desired processes.

Moreover, the systems and/or methods described herein may improve performance of the client terminal and/or network, by reducing the amount of storage space required to maintain an updated ad filter, signature database, black-list and/or other characteristics that may identify individual advertisements or families of advertisement (e.g., originating from a common source, such as an ad server). Such ad filters, which may need updates on a regular basis, may gradually increase in size to be able to identify newly produced ads. As the number of produced ads grows, the filter size may increase to be able to recognize the newly produced ads, requiring significant storage space.

The systems and/or methods described herein, which are at least partially based on extraction of classification feature that are common to different ad-related content, and/or are common to both ad-related content and user-accessed content, do not necessarily require such filters (e.g., based on specific ad or ad-family identification), occupying less storage space and/or requiring fewer computational resources to perform (e.g., instead of using a very large look-up table to match an ad). Moreover, updates of such filters may tie up network and/or client resources in transmission and/or implementation of the updates. The systems and/or methods described herein, which are based on classification feature extraction that allow for identification of new ad observations, do not necessarily require such updates, at least not as often as filters, and/or any classification feature extraction updates may require fewer client and/or network resources for transmission and/or implementation.

The systems and/or methods described herein may remove ad-related content embedded within the network document itself, for example, text embedded within the content of the network document, in addition to or instead or, for example, ad-related content that is accessed by a link from the network document, or inserted by an external entity into designated regions in the network document.

System 200 includes a network node 202 installed at the ISP level (e.g., of a tier 1 network, and/or transport network), for example, a server, a proxy server, a cellular radio access network computing device, a router, a bridge, and/or other computing units operating within the network at the ISP level. It is noted that the network node is a different computer than the client terminal.

Network node 202 includes a processing unit(s) 204, for example, a central processing unit(s) (CPU), a graphics processing unit(s) (GPU), field programmable gate array(s) (FPGA), digital signal processor(s) (DSP), and application specific integrated circuit(s) (ASIC). Processing unit 204 may include one or more processors (homogenous or heterogeneous), which may be arranged for parallel processing, as clusters and/or as one or more multi core processing units.

Users of client terminal 214 may access network node 202 to perform custom configuration, for example, by using software as a service (SaaS) provided by node 202 to client 214, using an application that allows the user to control options such as enabling/disabling ad blocking (as described herein) for local download to client 214, and/or providing functions using a remote access session to client 214 such as through a web browser.

Network node 202 includes and/or is in communication with a program store 206 (e.g. non-transitory computer readable storage media) storing code implementable by processing unit 204, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Network node 202 may include multiple computers (having heterogeneous or homogenous architectures), which may be arranged for distributed processing, such as in clusters.

Network node 202 includes and/or is in communication with a data repository 208 storing database(s), and/or other data items, for example, classifier repository 208A that stores code of a trained classifier (as described herein), and/or a classification feature repository 208B that stores classification features for extraction (as described herein).

Network node 202 includes a network interface 210 for communication with a network 212, for example, the internet, a private network, a cellular network, a wireless network, a local area network, or other networks.

Network node 202 may be in communication with one or more client terminals 214, for example, a personal computer, a mobile device (e.g., Smartphone, Tablet), a wearable device (e.g., computing glasses, computing watch), and/or a server. Each client terminal 214 is associated with one or more physical user interfaces, optionally a display and/or touch-screen 216 which allow a user to view presented data and optionally input data.

In use, client terminal 214 accesses a network document (e.g., web page), residing on network document server 218 (e.g. web server), using network 212 (e.g., internet). The network document includes web resource elements, and is in a data format designed for local rendering (e.g., by a web browser installed on the client terminal) and local presentation on display 216, for example, within the web browser. Ad server(s) 220 may insert one or more undesired ad-related content (e.g., data objects) such as text, audio, videos, and/or images into the network document, which are then displayed on the screen of the client terminal b the web browser.

Network node 202 may be located, optionally centrally, on a network transmission pathway between client terminal 214 and server 218 hosting the network document being accessed from client terminal 214, for example, located on a proxy server that processes, intercepts, and/or monitors packets passing through the network (e.g., router, other server. Network node 202 analyzes the data for rendering into the network document destined for presentation on display 216, to identify ad-related content. As described herein, network node 202 may remove and/or block the identified ad-related content, and/or inject code into the network document to correct for removal and/or block of the ad-related content (e.g., remove link problem messages, and/or correct formatting of user-accessed content). Network node 202 may deliver the filtered network document to the network, which transmits it to the client terminal for local rendering and local presentation. Network node 202 may process network documents in real-time, without introducing significant delay to the user experience, for example, without a noticeable delay to the user.

The blocks of the method described with reference to FIG. 1 may be implemented by processing unit 204 executing code stored in program store 206, of network node 202.

At 102, data for rendering into a network document is received, optionally by network node 202. The network document is, for example, a webpage(s), a video(s), an image(s), text, a word processing document(s), a sound file, and a portable document format (PDF) file(s). The data is, for example, HTML, CSS, and/or other instructions, script, and/or code. Data may be received as packets transmitted over the network, for example, internet protocol (IP) packets, and/or packets based on other protocols.

Client terminal 214 using a browser may request the network document from network document server 218, for transmission over network 212, for local rendering and presentation on display 216. The network document includes user-accessed content, for example, the original intended content, and ad-content such as advertisements (e.g., inserted by ad server 220 or by other methods). Ad-related content may include, for example, one or more images, banners, videos, text, audio messages, and pop-up windows.

The network document may be intercepted by network node 202 during transmission over network 212 to client terminal 214, may be placed in a queue for processing before further transmission to client terminal 214, or other methods.

Optionally, at 104, data objects are identified within the network document and/or data for rendering into the network document (i.e., web resource elements). The web resource elements and/or network document may be divided into the data objects. As used herein, the terms identifying and dividing of the data objects may sometimes be interchanged. For example, in an HTML file, the text of the HTML file may be dividing into data objects, and/or the rendered version (and/or estimated rendered version) of the HTML file may be divided into data objects. The rendered version of the network document may provide additional information over the data for rendering, for example, relative locations between data objects. Alternatively, the additional information is extractable from the data for rendering itself, without estimating the rendering. The data objects may overlap with each other (e.g., have common data) and/or may be contiguous. The entire network document may be divided, or portions thereof. In another example, the data objects are indentified as nodes of a document object model (DOM) tree of the web resource elements and/or the network document.

The division may be a natural division within the network document itself, for example, the network document may be pre-designated into regions of data objects. The division may be a processing of the network node, for example, division of paragraphs of text.

The data objects represents portions of data that are analyzed for classification into ad-related content or user-accessed related content, for example, images, video, banners, web code, audio (music and/or voice) and text.

The division into data objects may be based on object types and/or file formats, for example, files in a file format representing video (e.g., AVI, MPEG) may be identified and designated as independent data objects.

The division into data objects may be based on parsing of text, for example, data objects may be individual words, sentences, paragraphs, text, tags (e.g., hypertext markup language (HTML) tags), text between tags, and/or lines of code (e.g., script instructions).

The network document may be analyzed as a single data object, such as to determine relative locations between data objects.

Common data may be divided into multiple data objects, for example, different overlapping data objects may be designated from common text.

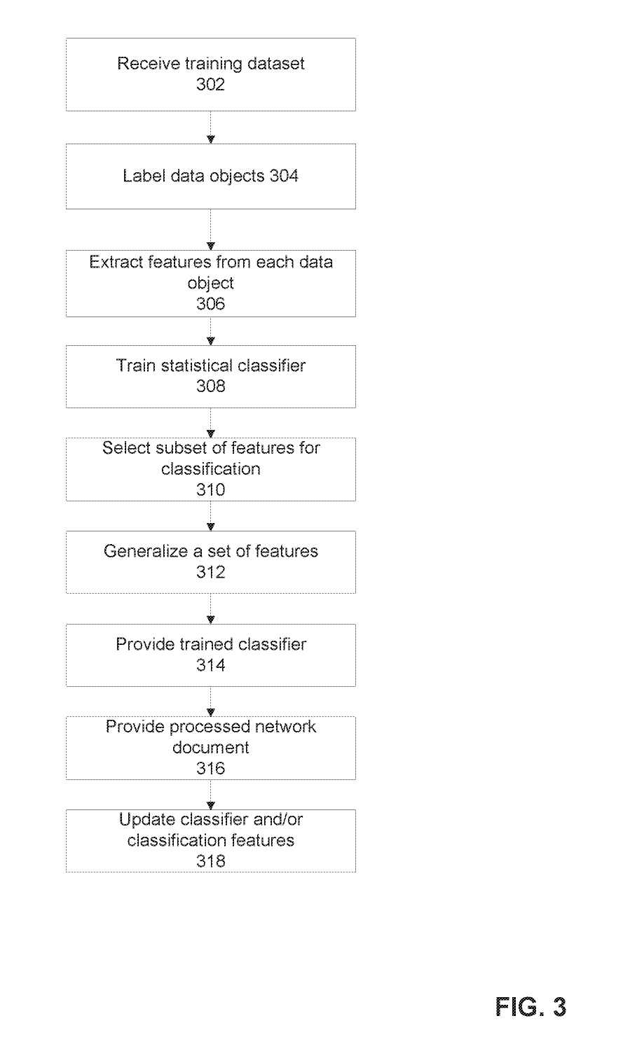

At 106, classification features are extracted from each data object. The classification features may be extracted according to the type of data object, for example, keypoint descriptors may be extracted when the data object includes an image, and words may be extracted when the data object includes text. The extracted classification features may be identified during a machine learning process, for example, as discussed with reference to FIG. 3. Classification features for extraction may be guided by classification features stored in classification feature repository 208B.

Optionally, classification features are extracted as a feature vector.

The extracted classification features may help differentiate between ad-related content and user-accessed related content. The extracted classification features may include differentiating classification features of ads, for example, classification features that may be statistically significantly correlated with ad-related content, and optionally statistically insignificantly correlated with user-accessed related content. For example, the word cola may appear more often in advertisements than in user-accessed content. Extraction of the word cola from a data object may be correlated with ad-related content.

The extracted classification features may include classification features that are common to different ad-related content objects. Such classification features may be extracted from different ads obtained from different sources, for example, different ad servers (i.e., different domain name system (DNS), URL), and/or different products, and/or different manufactures, and/or different service provides, and/or different advertising entities. For example, a particular common font may be favored by different advertisers, or a particular common image component favored by different advertisers (e.g., an image of a beach). For example, the word beer may be correlated to ad-related content, independently of the actual beer brand being advertised, the beer manufacturer, the advertising server, and/or the bar offering a special on beer.

The extracted classification features may include classification features that are common to ad-related content and user-accessed content. Optionally, the extracted classification features include classification features that are statistically insignificantly correlated with ad-related content and user-accessed related content. Such classification features may be extracted from both ad-related content and user-accessed related content. For example, the word advertisement may appear within user-accessed related content (such as a news article about advertising) and within ad-related content. Individually, such classification features may be statistically insignificantly correlated with ad-related content and/or with user-accessed related content. When multiple such classification features are extracted together, and/or extracted with other classification features described herein, the combination of classification features may allow for statistically significant classification of the data object into ad-related content and/or user-accessed related content. For example, individually, the words beach, vacation, and resort may be common to both ad-related content and user-accessed content, but in combination, the set of the words may be statistically significantly correlated with ad-related content.

Optionally, the extracted classification features include local visual classification features of an image and/or video. Local visual classification features may include descriptor, for example, keypoint descriptors and/or descriptions extracted using other image processing methods. Local visual classification feature may be extracted by image processing methods, for example, Scale-invariant classification feature transform (SIFT), Speeded up robust classification features (SURF), and histogram of oriented gradients (HOG). For example, identification of features related to a beer mug may be correlated with ad-related content.

Alternatively or additionally, the extracted classification features include a location of the respective data object within the network document, optionally a relative location, for example, located at the top of the page (or on the side, or bottom), located within another data object (e.g., image located within text, script code or tags located within text), located next to another data object (e.g., image located next to text). The relative location may be statistically associated with ad-related content or user-accessed related content, for example, ad-related content may be expected to appear within designated places in the network document (e.g., at the top of the page).

Alternatively or additionally, the extracted classification features include static metadata related to the respective ad object, for example, instructions and/or other code designating where to insert ad-related content within user-accessed related content.

Alternatively or additionally, the extracted classification features include a graph representation of the network document. The extracted classification features may include the nodes and/or edges of the graph. For example, certain graph structures (or portions thereof) may be statistically correlated with ad-related content, and other graph structures (or portions thereof) may be statistically correlated with user-accessed related content.

Alternatively or additionally, the extracted classification features include classification feature extracted from sound files, for example, based on speech recognition, based on frequency patterns, and/or other audio related data.

At 108, each data object is classified by a statistical classifier into one or more predefined content categories. The classification category includes at least ad-related content, for example, in a single category classifier which is able to classify the data object as ad-related content or not, and/or in a multi-category classifier which classifies the data object into one of several categories that include ad-related content.

Optionally, a categorization category includes user-accessed related content. Optionally, the categorization categories include a media types of ad-related content, for example, banner, video, image, audio, and text. The media type may allow for blocking of ad-related content, instead of, for example, methods that block a common media type (e.g., video) regardless of whether the media type is ad-related or user-accessed related.

The classifying is performed by a trained statistical classifier that is trained using a training dataset of ad-related content data objects and user-accessed related content, for example, as described with reference to FIG. 3. The trained statistical classifier receives the extracted classification features as input, and outputs the classification category of the data object. The trained statistical classifier may output a probability of accuracy of the classification.

The data object being classified may represent a new observation to the trained statistical classifier. The new observation may not have been part of the training set used to train the statistical classifier, for example, a newly released ad, an ad arriving from a new location, and/or an ad in a foreign language. The new observation may be entirely new, optionally independent of previous observations (i.e., data objects), for example, from a new DNS, a new ad-server, a new URL, and/or other new ad sources. In this manner, the statistical classifier may classify new observations (i.e., new data objects), without necessarily having to have been trained on the respective observation, in contrast, for example, to methods that identify ad-related content that is pre-known, as such methods are unable to identify ad-related content that represents new observations.

At 110, an indication of the classification of each data object is outputted. The categorization of the data objects may be saved on a storage device, locally and/or remotely. The categorization of the data objects may be presented to the user on display 216, for example, messages such as “No ads have been found”, or “2 ads have been found”.

Optionally, at 112, when at least one ad-related data object (or other classified object) has been indentified within the network document, the ad-related (or other classified) data object may be blocked and/or removed from the network document.

Optionally, at 113, reformatting instructions are automatically generated based on the classified data objects. The reformatting instructions are created to adapt the presentation of the network document (i.e., when locally rendered by the client terminal for presentation on the display associated with the client terminal). The adaptation may include reducing visibility of the classified data objects upon rendering of the network document. Screen space that would otherwise have been used by the classified data objects may be available for other processes and/or to display other content of the network document. It is noted that removal and/or blockage of the classified data objects may not necessarily be sufficient to free up the screen space at the client terminal, for example, the screen space may otherwise be blank and/or display an error. The reformatting instructions are generated to free up the screen space that would otherwise be utilized by the blocked and/or removed classified data objects.

Examples of reformatting instructions (e.g., code) include Javascript code elements, Cascading Style Sheets (CSS) code, and/or other code formats.

Optionally, at 114, a formatted network document is created based on the generated reformatting instructions. Optionally, the reformatting instructions (e.g., code, script) is injected into the network document (and/or other methods of inserting instructions may be used) to create the formatted network document. The code includes instructions to reduce and/or prevent effects of blocking and/or removing the ad-related content, which may be unintended effects.

The code may include instructions to prevent errors due to the blocking and/or removal, for example, messages, icons, and/or other presentations indicative of missing content, and/or broken links.

The code may include instructions to reformat remaining user-accessed related data objects. The reformatting may be according to the blocking and/or removing of the ad-related objects, for example, user-accessed data objects may be moved around and/or expanded to cover regions designated for ad-related content, instead of, for example, leaving such regions empty and/or displaying error messages.

The injected code may be automatically and/or semi-automatically generated according to an automated and/or semi-automated analysis of data objects (optionally user-accessed data objects) in the vicinity of the blocked and/or removed ad-related data object.

The injected code may be created based on one or more of the extracted classification features, such as classification features stored in classification feature store 208B. For example, code may be injected in the location (e.g. in addition to, or replacement of) of the data which is extracted as the classification feature. For example, when the extracted classification feature includes tags or text representing a link to a remote ad-server, the injected code may disable the link in a manner such that errors in accessing the link do not appear (e.g., delete the link).

Optionally, at 116, the formatted network document (e.g., with blocked and/or removed ad-related data objects, and/or optionally with the injected code) is provided by the network node to the network, for transmission to client terminal 214 for local rendering and presentation on display 216.

Optionally, at 118, when one or more of the data objects represent new observations, the statistical classifier is updated to reflect the new observation. Optionally, the statistical classifier is updated when a new ad-related data object is identified.

Reference is now made to FIG. 3, which is a flowchart of a method for training a statistical classifier to classify data objects of data for rending into a network document as ad-related, in accordance with some embodiments of the present invention. The method of FIG. 3 may be implemented by the system of FIG. 2. The trained classifier generated by the method of FIG. 3 may be used to classify data objects by the method of FIG. 1.

Classification feature extraction and statistical classification may be computationally intensive, requiring significant computation resources (e.g., processor(s) and/or storage space) and/or significant time to perform. The systems and/or methods described herein allow for selection of classification features that may be used to perform classifications of data object within a network document in real-time, optionally without adding significant delay to loading of the network documents (e.g., webpages) for presentation on a display associated with the client terminal, for example, no more than about 0.1 second, or about 0.5 second, or 1 second, or 3 seconds, or 5 seconds.

The training may be performed by processor 204 implementing code stored in program store 206. The trained classifier may be stored in classifier repository 208A. Alternatively or additionally, the training may be performed by another network node, for example, a remote central server, with the trained classifier distributed to one or more network node 202 for centralized processing of data for rendering into network documents. In this manner, centrally trained statistical classifiers may be distributed to multiple remote locations for local classification.

At 302, a training dataset of data for rendering into network documents is received. Each network document may be divided into data objects, for example, as discussed with reference to block 104 of FIG. 1. Each network document may include ad-related content and user-accessed related content.

Optionally, at 304, each data object is associated with and/or assigned a classification label of a predefined content category (e.g., using a supervised approach). The classification label may represent at least ad-related content. Optionally, the classification labels represent user-accessed related content, and/or other classifications, for example, media type of ad-related content. The classification labels may correspond to the classification labels discussed with reference to block 108 of FIG. 1.

The labeling may be performed manually, for example, by a user or administrator assigning labels to the data objects. Alternatively or additionally, labeling is automatically performed by code implementable by the processing unit.

Labeling may be automatically performed, for example, using application programming interfaces (APIs) to label sources of the data objects, for example, data objects retrieved from known ad-servers are labeled as ad-related. Labeling may be manually performed, for example, using an interactive software module that requires user intervention. Examples of automatic labeling software applications include: previously labeled applications that were vetted by known products, signature based tools for automatic labeling, mechanical turk methods to systematically analyze a large set of applications of the different classes, and/or other labeling methods.

Images may be automatically labeled by a classifier (or other method) that applies computer vision and/or other image processing methods, for example, using deep learning methods.

Examples of labels of predefined categories include: Ad, User-accessed content, Benign Content, Intrusive ad, or other categories.

Alternatively or additionally, a non-supervised and/or semi-supervised approached is used, in which the data objects are clustered. The data objects in each cluster may be labeled with a common label, which may be one of the designated labels when the cluster is correlated with the label, and/or arbitrary names.

Optionally, the set of labeled data objects are filtered, to select a subset of labeled data objects according to a classification confidence requirement. The requirement may represent a high statistical confidence in accuracy of the labeling using automatic methods. It is noted that manual labeling may be associated with high confidence, based on the assumption that the user is correct.

A set of data objects is generated with corresponding classification type. Labeling may be 1:1 between data object and classification label, or mapping that is other than 1:1, for example, the same data object may receive multiple labels.

At 306, classification features are extracted from each data object. Details of classification feature extraction have been discussed with reference to block 106 of FIG. 1. The classification features extracted as part of the training may be a larger set of classification features, from which a subset of classification features is selected for implementation in block 106.

The broader set of classification features may include classification features extracted from data of the data object, metadata associated with the data object, static metadata associated with the content, and/or metadata associated with the network document. Examples of classification features include: URL, domain name, HTML tags, CSS, image content, and/or other quantifiable measures. In the case of images, descriptors may be extracted, and/or convolutional networks used in deep learning.

Extracted classification features may be stored as classification features vectors. Extracted classification features may be placed in ordered buffers. The extracted classification features may be stored, for example, in classification feature repository 208B.

At 308, one or more machine learning methods are applied using the extracted classification features and related classification labels. A statistical classifier is trained for classification of a newly received data object, using the extracted classification features and the classification label associated with respective data objects.

Machine learning may processed in a supervised manner and/or unsupervised manner. Examples of supervised machine learning methods include neural networks, support vector machines, deep learning, decision trees, hard and/or soft thresholding, naive bayes classifiers, and/or other methods. Examples of unsupervised machine learning methods include K-nearest neighbors (KNN) clustering, Gaussian Mixture Model (GMM) parameterization, or other methods. It is noted that combinations of methods may be applied, sequentially and/or simultaneously.

The trained statistical classifier may be represented as a vector and/or matrix of coefficients, and/or a set and/or tree of decision rules. Each node (or other position) in the vector and/or matrix may be associated with a respective classification feature (e.g., within the feature vector).

Optionally, at 310, a subset of the classification features for extraction from each data object is selected.

Selection may be performed according to a real-time computing performance requirement of a computing device (e.g., network node) and/or a network in a transmission pathway of the network document transmitted from the server to the client terminal for presentation on a display associated with client terminal. For example, the classification features may be selected to perform the analysis of the network document (e.g., as described with reference to FIG. 1) using a predefined limit in terms of processing resources, storage requirements, time to process, and/or to reduce network resource utilization below a threshold or within a range (e.g., bandwidth requirements, packet delays, and the like). The classification features may be selected to allow for real-time processing of the network document (e.g., as described with reference to FIG. 1).

The vector and/or matrix representation of the classifier may be sorted according to coefficient values. The highest values, which may represent the most statistically significant classification features, may be selected.

Optionally, at 312, a single generalized classification feature is created for at least one set of extracted classification features designated from the selected classification features. The single generalized classification features includes each member of the set of extracted classification features. The set of selected classification features may be replaced with the single generalized classification feature. In this manner, the total number of extracted classification features may be reduced, while optionally maintaining the ability to perform statistical significant classification.

At 314, the trained classifier is provided to network node(s) located within a network, for real-time identification of ad-related data objects in data for rendering into the network document. The trained classifier may be stored in classifier repository 208A, and/or distributed to other servers for local classification.

The set of classification features, including the generalized classification features are provided, for extraction of classification features from data objects for classification using the trained classifier. The set of classification features may be stored in feature repository 208B.

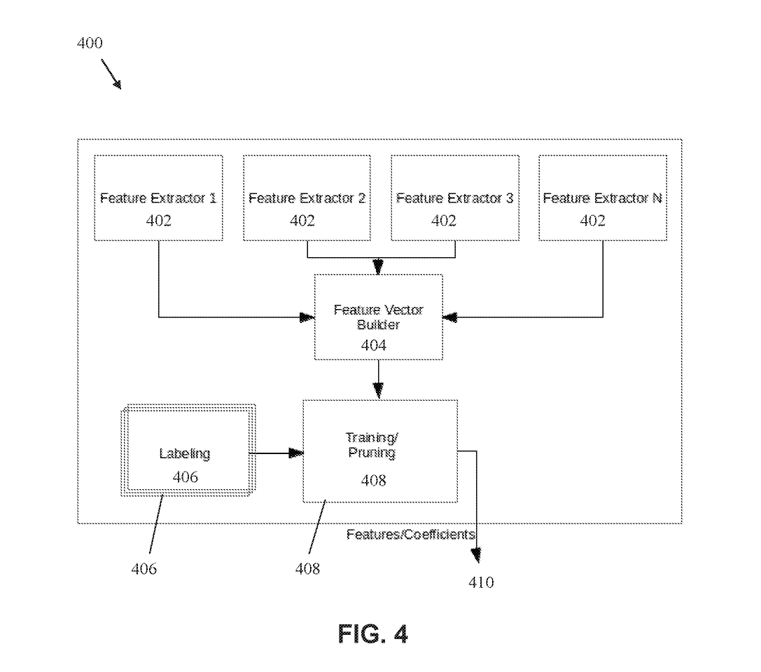

Reference is now made to FIG. 4, which is a dataflow diagram of exemplary dataflow for creating a classifier that classifies data objects as ad-related, in accordance with some embodiments of the present invention. The dataflow diagram of FIG. 4 may be implemented by the system described with reference to FIG. 2, for use by the classifier described with reference to FIG. 1, and/or based on the method discussed with reference to FIG. 3.

Multiple classification feature extractors 402 extract different classification features from data objects of data for rendering into a network document, as described herein. The classification features may be represented by a classification feature vector 404. The data objects are labeled 406, at least including a representation of ad-related content and optionally user-accessed related content, as described herein. A statistical classifier is trained 408 based on the extracted classification features and associated labels. The set of classification features and/or coefficients is reduced to a subset thereof, according to a performance requirement, optionally to allow real-time implementation, as described herein. The selected subset of classification features and/or coefficients 410, which represent the trained classifier, are provided, optionally to a network node for implementation within a network on network documents being accessed by a client terminal, as described herein.

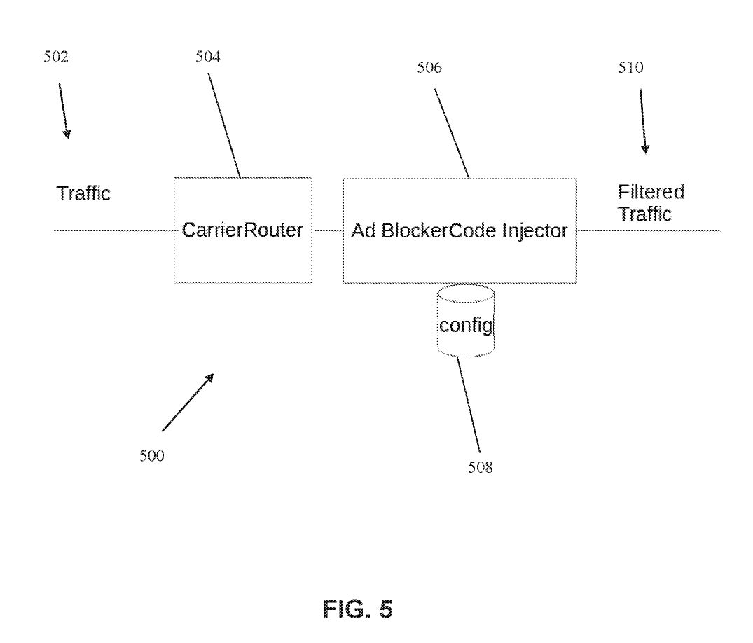

Reference is now made to FIG. 5, which is a dataflow diagram depicting a network node processing network traffic including data for rending into network documents, and providing network traffic including filtered network documents for transmission to client terminals for local rending and presentation of the network documents, in accordance with some embodiments of the present invention. The dataflow diagram of FIG. 5 may be implemented by the system described with reference to FIG. 2, and/or by the method described with reference to FIG. 1.

Network traffic 502 includes data for rendering into a network document with ad-related content and user-accessed related content, is received at a network node 504, for example, an ISP proxy server and/or carrier router. Network traffic 502 may include packets and/or other network messages, for example, internet protocol packets travelling on the internet and/or other networks. The network traffic 502 may be received during a transmission route from a server hosting the network document to a client terminal accessing the server to obtain the network document. Ad-related content within the data for rendering into the network document is identified, and blocked and/or removed 506. Code may be injected into the data and/or network document to correct errors and/or other undesired effects of the blocking and/or removal. The ad-related content may be identified based on a pre-configured trained statistical classifier 508. Filtered traffic 510, which includes the data for rendering into the network document with the blocked and/or removed ad-content, and optionally with injected code continues transmission along the network. The filtered traffic is received by the client terminal from the network, for local rendering and local presentation on a display associated with the client terminal. The user is presented with a corrected rendered network document without ad-related content and/or without errors, which is optionally formatted to correct for removal and/or blocking of the ad-related content.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant classifiers, network documents, and data objects will be developed and the scope of the terms classifiers, network documents, and data objects are intended to include all such new technologies a priori.

As used herein the term “about” refers to±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method of identifying at least one data object of a predefined content category within a network document for presentation at a client terminal, comprising:
receiving, at a network node at an internet service provider (ISP) level of a network, web resource elements of a network document for rendering and presentation on a display associated with a client terminal;
identifying a plurality of data objects within the network document;
extracting a plurality of classification features from each data object;
classifying at least one of the data objects into a predefined content category;
generating reformatting instructions for adapting the presentation of the network document to reduce visibility of the data objects classified into the predefined content category upon rendering of the network document;
creating a formatted network document by injecting the reformatting instructions into the network document for implementation by a rendering process executing on the client terminal; and
transmitting the formatted network document to the client terminal.

2. The method of claim 1, wherein the predefined content category is ad-related content or user accessed content.

3. The method of claim 1, wherein at least some extracted classification features are at least one of: common to different ad-related content objects, and common to ad-related content and user-accessed content.

4. The method of claim 3, wherein the extracted classification features include classification features that are statistically insignificantly correlated with ad-related content and user-accessed related content.

5. The method of claim 3, wherein the extracted classification features common to different ad-related content objects comprises extracted classification features common to different ad-related content objects originating from different ad server sources.

6. The method of claim 1, wherein the classifying is performed on at least one new data object representing a new observation to a trained statistical classifier performing the classifying, that at least one new data object excluded from a training set used to train the statistical classifier.

7. The method of claim 1, further comprising:
at least one of blocking and removing the classified objects from the network document; and
wherein generating reformatting instructions comprises generating reformatting instructions to at least one of: prevent errors from the blocking and removing of the classified objects, and reformat remaining data objects according to the blocking and removing of the classified objects.

8. The method of claim 1, wherein the injected code is automatically generated according to an analysis of data objects in the vicinity of each data object classified into the predefined content category.

9. The method of claim 1, wherein the extracted classification features include a relative location of the respective data object within a rendered version of the network document.

10. The method of claim 1, wherein the classifying is performed by a trained statistical classifier that is trained using a training dataset of data objects tagged with the predefined content category and other data objects not tagged with the predefined content category.

11. The method of claim 1, wherein the extracted classification features include local visual classification features of an image or video.

12. The method of claim 1, wherein the extracted classification features include static metadata related to the respective data object of the predefined content category.

13. The method of claim 1, wherein the extracted classification features include a graph representation of the network document.

14. The method of claim 1, wherein classifying comprises classifying a media type of the data object, and outputting comprises outputting an indication of the identified media type.

15. The method of claim 1, wherein the plurality of data objects comprises at least one of: images, video, banners, web code, and text.

16. A network node at an ISP level of a network for identifying at least one predefined content category data object within a network document for presentation at a client terminal, comprising:
a network interface for communication with a network at the ISP level transmitting web resource elements of a network document for rendering and presentation on a display associated with a client terminal;
a program store storing code; and
a processor coupled to the network interface and the program store for implementing the stored code, the code comprising:
code to identify a plurality of data objects within the network document, extract a plurality of classification features from each data object, and classify at least one of the data objects into a predefined content category, generate reformatting instructions for adapting the presentation of the network document to reduce visibility of the data objects classified into the predefined content category upon rendering of the network document, create a formatted network document by injecting the reformatting instructions into the network document for implementation by a rendering process executing on the client terminal; and
code to transmit the formatted network document to the client terminal using the network interface.

17. The system of claim 16, further comprising code to at least one of block and remove the classified data objects from the formatted network document, and wherein generating code comprises generating reformatting instructions to at least one of: prevent errors from the blocking and removing of the data objects, and reformat remaining data objects according to the blocking and removing of the ad-related data objects.

18. The system of claim 17, wherein the network node is located on network transmission pathway between the client terminal and a server hosting the network document.

19. A method for training a statistical classifier to classify objects of a network document into a predefined content category for presentation at a client terminal, comprising:
receiving a training dataset of web resource elements of a network document for rendering and presentation on a display associated with a client terminal, each network document associated with a plurality of identified data objects, each data object associated with a classification label representing the predefined content category or not representing the predefined content category;
extracting a plurality of classification features from each data object, wherein at least some extracted classification features are at least one of: common to different data objects of the same predefined content category, and common to different data objects of different categories; and
training a statistical classifier for classification of a newly received data object excluded from the training dataset, using the extracted classification features and the classification label associated with respective data objects; and
providing the trained classifier to a network node at the ISP level in communication with at least one client terminal over a network, for centralized real-time classification of data objects into the predefined content category and reformatting the network document by injection of reformatting instructions therein to reduce visibility of the classified data objects upon rendering of the formatted network document by a client terminal.

20. The method of claim 19, further comprising creating, for at least one set of extracted classification features, a single generalized classification feature that includes each member of the set of extracted classification features.

21. The method of claim 19, further comprising selecting a subset of the classification features for extraction from each data object according to a real-time computing performance requirement of at least one of a network node and a network in a transmission pathway of the data for rendering into the network document transmitted from the network document server to the at least one client terminal for local rendering and presentation on a display associated with client terminal.

22. The method of claim 19, wherein each network document comprises ad-related content and user-accessed content from a network document server, wherein the predefined content category represents at least ad-related content.
